(19) United States
(12) Patent Application Publication
(10) Pub. No.: US 2006/0080612 A1
(43) Pub. Date: Apr. 13, 2006

(54) Dynamic portlet tabbing

(75) Inventors: Kent Fillmore Hayes JR., Chapel Hill, NC (US); Steven Paul Kim, Raleigh, NC (US); Robert Charles Leah, Cary, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/960,343

(22) Filed: Oct. 7, 2004

(51) Int. Cl. G06F 17/00; G06F 17/21

(52) U.S. Cl. 715/742; 715/513

(57) ABSTRACT

A method, apparatus, and computer instructions for presenting portlets in a document. A set of portlets are presented using a single portlet window in the document. The portlet window includes a set of tabs used to manipulate the portlets. Responsive to a selection of a particular tab in the set of tabs, content for a particular portlet associated with the particular tab in the set of tabs is presented. Functions may be provided to manipulate the portlets in the portlet windows.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for managing a display of data in a data processing system.

2. Description of Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called transmission control protocol/Internet Protocol (TCP/IP).

The Internet has revolutionized communications and commerce, as well as, being a source of both information and entertainment. For many users, email is a widely used format to communicate over the Internet. Additionally, the Internet is also used for real-time voice conversations.

With respect to transferring data over the Internet, the World Wide Web environment is used. This environment is also referred to simply as “the Web”. The Web is a mechanism used to access information over the Internet. In the Web environment, servers and clients effect data transaction using the hypertext transfer protocol (HTTP), a known protocol for handling the transfer of various data files, such as text files, graphic images, animation files, audio files, and video files.

On the Web, the information in various data files is formatted for presentation to a user by a standard page description language, the hypertext markup language (HTML). Documents using HTML are also referred to as Web pages. Web pages are connected to each other through links or hyperlinks. These links allow for a connection or link to other Web resources identified by a universal resource identifier (URI), such as a uniform resource locator (URL).

A browser is a program used to look at and interact with all of the information on the Web. A browser is able to display Web pages and to traverse links to other Web pages. Resources, such as Web pages, are retrieved by a browser, which is capable of submitting a request for the resource. This request typically includes an identifier, such as, for example, a URL. As used herein, a browser is an application used to navigate or view information or data in any distributed database, such as the Internet or the World Wide Web. A user may enter a domain name through a graphical user interface (GUI) for the browser to access a source of content. The domain name is automatically converted to the IP address by a domain name system (DNS), which is a service that translates the symbolic name entered by the user into an IP address by looking up the domain name in a database.

The browser includes a user interface, which is a GUI that allows the user to interface or communicate with another browser. This interface provides for a selection of various functions through menus and allows for navigation. For example, a menu may allow a user to perform various functions, such as saving a file, opening a new window, displaying a history, and entering a URL.

With respect to obtaining information on the Internet, portal based user interfaces are becoming increasingly popular because these types of interfaces allow the user to see user interfaces, also referred to as portlet windows, which gather data from many different sources going into a single hypertext mark-up language (HTML) page.

Portlets are a series of related tasks, presented to a user within the context of a Web page in a portal environment. Currently, no limit is present as to the number of portlets that may be presented to a user within a Web page. The portlets are located on the server and the data from these portlets are presented in portlet windows on the global Web page. A portlet is launched onto a page from another portlet, two possible outcomes may occur with the situation. One is that the new portlet may be presented in a portlet window on the page such that multiple incidences of the same portlet exist on the same Web page. Alternatively, a new portlet window may replace an existing portlet window.

As additional portlets are launched onto a Web page, this page becomes difficult to manage due to the sheer size and number of portlet windows being displayed on the page. With numerous portlet windows presented on a page, a user may have difficulty in finding information that the user desires. The user may have to scroll up and down or left and right within the page to find the information desired.

Therefore, it would be advantageous to have a method, apparatus, and computer instructions for presenting portlets in a Web page.

### BRIEF SUMMARY OF THE INVENTION

The present invention provides an improved method, apparatus, and computer instructions for presenting portlets in a document. A set of portlets are presented using a single portlet window in the document. The portlet window includes a set of tabs used to manipulate the portlets. Responsive to a selection of a particular tab in the set of tabs, content for a particular portlet associated with the particular tab in the set of tabs is presented. Functions may be provided to manipulate the portlets in the portlet windows.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in providing dynamic portlet tabbing in accordance with the preferred embodiment of the present invention;

FIG. 5 is a diagram of a container used in dynamic portlet tabbing in accordance with a preferred embodiment of the present invention;

FIG. 6 is a flowchart of a process for managing portlets in a portlet window in accordance with a preferred embodiment of the present invention;

FIG. 7 is a flowchart of a process to add a portlet to a portal page in accordance with a preferred embodiment of the present invention; and

FIG. 8 is a flowchart of a process for performing functions on portlets in a container in accordance with a preferred embodiment of the present invention.

### DETAILED DESCRIPTION OF THE INVENTION

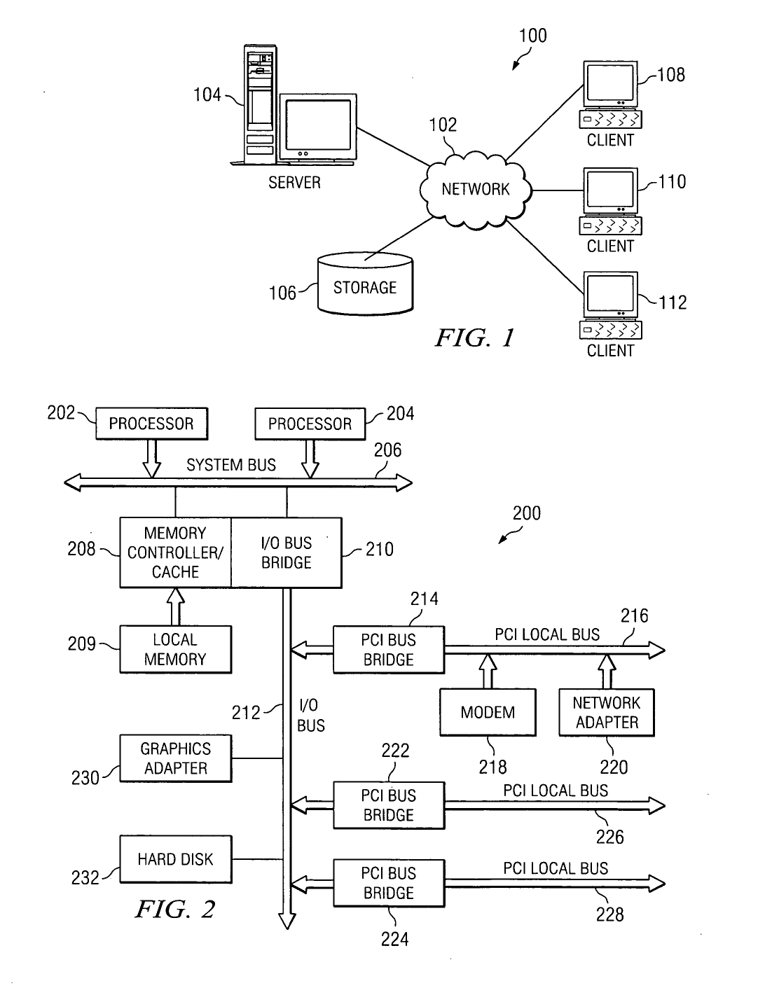

With reference now to the Figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110, and 112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108, 110, and 112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

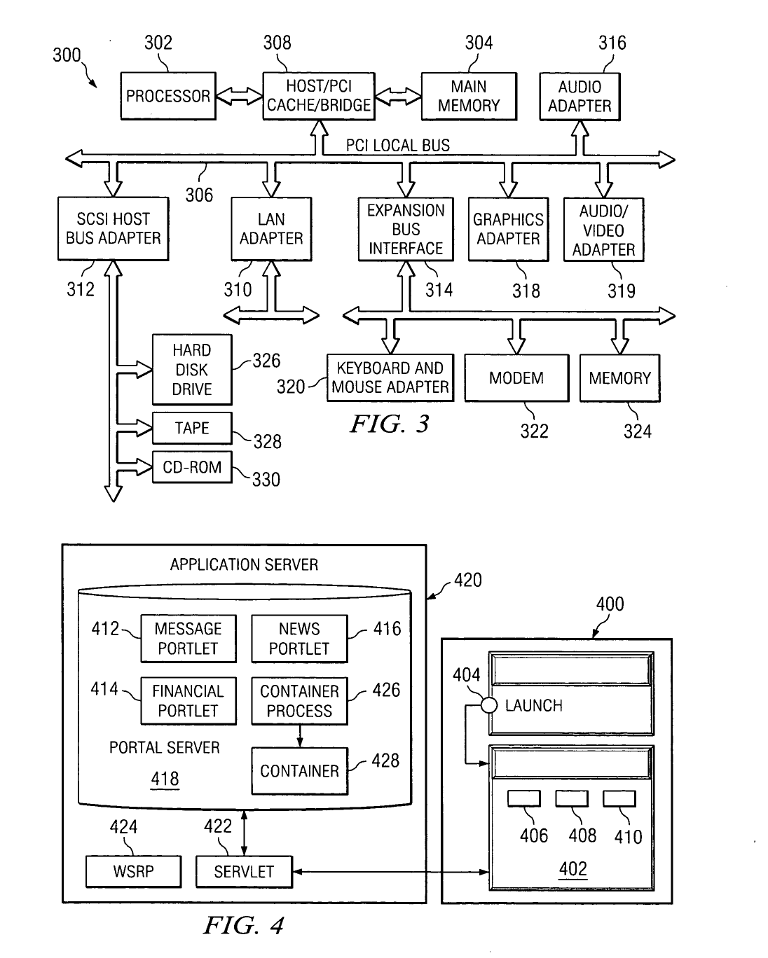

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With the current mechanisms for presenting portlet information in a Web page, a user often finds difficulty in managing the information due to the sheer size and number of portlet windows. The present invention recognizes that a user may desire to consolidate multiple instances of a portlet window into a single view. Currently available systems do not provide a means to consolidate these different views.

To overcome these and other problems, the present invention provides an improved method, apparatus, and computer instructions for presenting a document that contains portlet windows. In particular, the document is a Web page, which is specifically called a portal page in these examples. This Web page or document may be presented using various mechanisms, such as a mark-up language. In these examples, the mark-up language is HTML. Of course, the mechanism of the present invention may be applied to other types of mark-up languages or systems for displaying portlet windows.

The mechanism of the present invention presents a set of portlets using a single portlet window in the document. The portlet window includes a set of tabs. In these examples, tabs are a set of graphical controls that may be manipulated by the user through the graphical user interface. In response to a selection of a particular tab in a set of tabs, the concept for a particular portlet associated with the particular tab within the set of tabs is presented or manipulated.

Further, the mechanism of the present invention allows for intelligent grouping and access to related portlets via the tabbing mechanism. Additionally, the use of real estate on a given page is maximized through this mechanism, allowing the consolidation of data for portlets into a single view.

Further, the mechanism of the present invention allows flexibility by allowing a user to break out portlets from dynamic tabbing or close portlets without requiring the need to search for portlets on a portal page.

Also, local grouping of portlets may provide for aggregate functions. For example, a user may print all of the portlets grouped into a single view. Other functions such as close, submit, or resizing may be performed for the group of portlets presented in a portlet window.

In grouping portlets within a portlet window, a container is created for the different portlets. This container is used to keep track of portlets that are presented within a single portlet window within a portal page. A container process manages the addition and removal of portlets from this container as well as initiating different functions on the portlets in the container.

Turning now to FIG. 4, a diagram illustrating components used in providing dynamic portlet tabbing is depicted in accordance with the preferred embodiment of the present invention. In this example, portal page 400 is displayed within a browser. In this example, portal page 400 contains portlet window 402. In these examples, a portlet window contains content generated by one or more portlets. These portlets are Java-cached based Web components that process requests and generate dynamic content. Without the mechanism of the present invention, each time a control, such as control 404, is selected to launch a portlet window; a portlet window is launched into multiple locations within portal page 400. Alternatively, a portlet launch may replace the previous portlet on the portal page.

The mechanism of the present invention allows for the information to be managed without having to re-launch the page each time the information for a particular portlet is desired. The mechanism of the present invention includes tabs, which are graphical controls that may be manipulated by a user to select and manipulate different views for portal window 402.

In this example, portlet window 402 is a dynamically tabbed portlet window in which multiple views for different portlets may be managed in a single portlet window. For example, portlet window 402 may contain news for a message portlet, a financial portlet, and a news portlet.

In these examples, tabs 406, 408, and 410 are present. The grouping of portlet information into portlet window 402 may be selected by a user or by some other grouping to allow consolidation of information into a single portlet window.

In this example, message portlet 412, financial portlet 414, and news portlet 416 are located in portal server 418 on application server 420. When portlet window 402 is launched through user input to control 404, a request is sent to servlet 422 on application server 420. Servlet 422 is a Java application that runs on a Web server or an application server and provides service by processing request. This processing may include, for example, accessing a database or performing e-commerce transactions.

In this particular illustrative example, the processing by servlet 422 includes accessing message portlet 412, financial portlet 414, and news portlet 416 in portal server 418. This access is providing through Web services for remote portlets (WSRP) interface 424. In these illustrative embodiments, WSRP is a protocol used as opposed to any proprietary universal resource locator encoding because this interface allows application server 420 to work across multiple portal vendors and also allows a portlet, such as financial portlet 414 to be located on a remote portal server for remote portlets. This type of interface provides a Web service interface for accessing and interacting with interactive-oriented Web services. More information on this type of interface may be found in Web Services for Remote Portlets Specification 1.0, which is incorporated herein by reference. Also, more information of portlets and their uses and implementations may be found in Java Portlets Specifications, Version 1.0, which is incorporated herein by reference.

The mechanism of the present invention includes container process 426, which implements the process used to manage the presentation of portlets in portlet window 402. Container process 406 may initiate functions on the portlets contained in container 408. In these examples, the portlets contained in container 428, include message portlet 412, financial portlet 414, and news portlet 416. Requests to manipulate contents in portlet window 402 are directed to container process 426 by servlet 422. The generation of HTML code is performed by portal server 418 for the different portlets.

In these examples, the mechanism of the present invention uses the infrastructure of “Click-To-Action” currently used launch portlets on a given portal page. The mechanism of the present invention employs this established technique with a dynamic portlet tabbing infrastructure to provide users the ability to customize and control how portlets are grouped together. In these illustrative examples, this infrastructure includes container process 426 and container 428.

When portlets are dynamically grouped together, as shown in portlet window 402 in FIG. 4, the user also has the ability to perform consolidated functions across the portlets, such as “Close All portlets” or “Print all portlet”. In theses examples, container process 426 is responsible for handling these and other functions for the portlets grouped within container 428. In these illustrative examples, the functions are general to all portlets specified by a standard set of portlet application programming interfaces.

By allowing portlets the ability to dynamically group via the portlet tabbing component, the user can save real estate space and perform common functions to all grouped portlets. In addition, the user will have the ability to also perform single actions against a grouped portlet, such as “breaking out” a tabbed portlet from the group. In addition to grouping portlets together, the mechanism of the present invention may be used to remove a portlet from a container. This removal also is referred to as “breaking out”. The portlet then appears in the portal page, separate from the portal window for the grouped portlets.

In these examples, the tabbed portlet component depicted in portlet window 402 only appears when at least two portlets are grouped together. The tab of a portlet, such as tab 406, contains the title of the portlet; when the user clicks on this tab, the portlet appears below the row of tabbed portlets in portlet window 402.

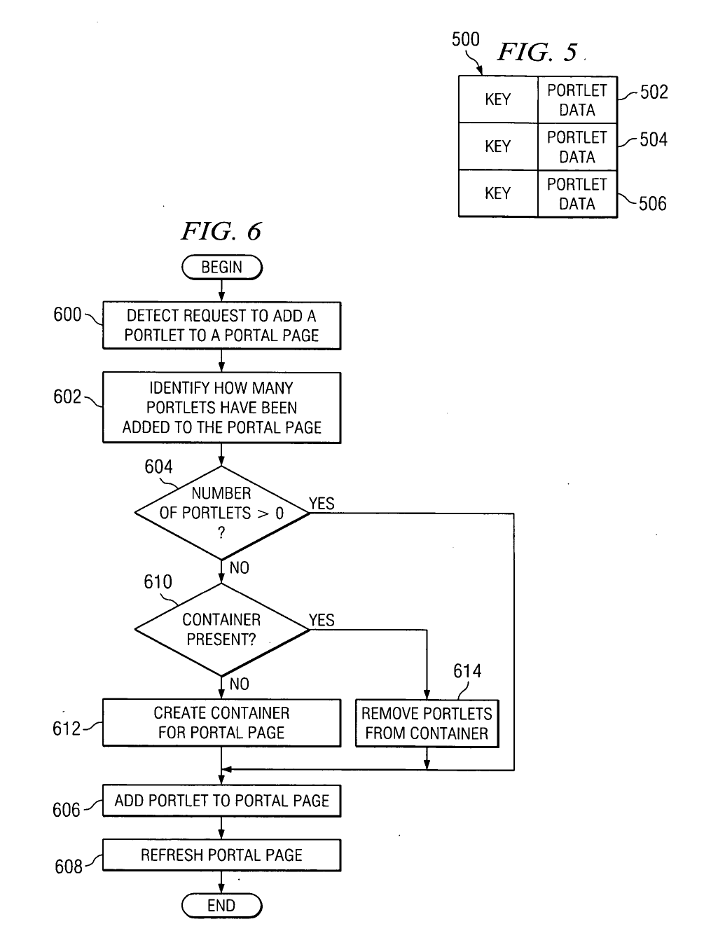

Turning now to FIG. 5, a diagram of a container used in dynamic portlet tabbing is depicted in accordance with a preferred embodiment of the present invention. Container 500 in FIG. 5 is an example of a container, such as container 428 in FIG. 4. In this example, container 500 takes the form of a data structure containing a hashmap. Container 500 is used to track portlets being presented in a portlet window, such as portlet window 402.

In this illustrative example, container 500 includes entries 502, 504, and 506. Each of these entries contains a key and portlet data. The data in these entries is used for accessing the portlet on the portal server. The portlet data includes, in theses examples, a PorletContext object. This object is an interface that defines a portlet view of the portlet. Other objects such as ActionRequest and RenderRequest also are present to allow the portlet to store and retrieve property value contained within the portlet and portal environment. The key value for the key is generated using the title of the portlet in these examples. Container 500 is accessed when the portlets are added or removed. This data structure also is accessed when a specific portlet is requested.

Turning to FIG. 6, a flowchart of a process for managing portlets in a portlet window is depicted in accordance with a preferred embodiment of the present invention. The process illustrated in FIG. 6 may be implemented in a container process, such as container process 426 in FIG. 4. This process allows a user to select and customize how portlets are used and grouped together. The user may employ this process to select which portlets are to be presented in a portlet window.

The process begins by detecting a request to add a portlet to a portal page (step 600). The identification of how many portlets have been added to the portal page is made (step 602). This identification may be made by accessing a data structure, such as container 600 in FIG. 6.

A determination is made as to whether the number of portlets in the portal page is greater than zero (step 604). If the number of portlets is greater than zero, the portlet requested in step 600 is added to the portal page (step 606). The portal page is the refreshed (step 608) with the process then terminated thereafter. When a page is refreshed, all data contained within all portlets on the page is refreshed. During the refresh, a call is made to the portal server, in which a call to each portlet is executed. Results from the execution of these calls are formulated in HTML and are sent back to the Web browser for display within each portlet.

With reference again to step 604, if the number of portlets is not greater than zero, a determination is made as to whether a container is present to hold portlets for the portal page (step 610). If a container is not present, a container is created for the portal page (step 612) with the process then proceeding to step 606 as described above.

Turning back to step 610, if a container is present for the portal page, any portlets located in the container are removed (step 614). The process then proceeds to step 606.

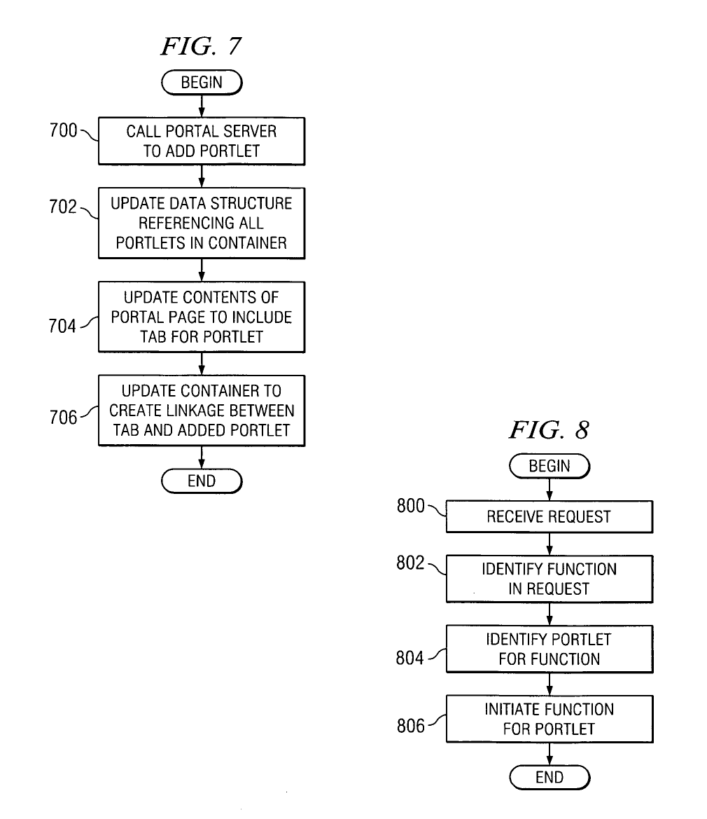

In FIG. 7, a flowchart of a process to add a portlet to a portal page is depicted in accordance with a preferred embodiment of the present invention. The process illustrated in FIG. 7 is a more detailed description of step 606 in FIG. 6.

The process begins by calling a portal sever to add the portlet to the container (step 700). The Model View Controller (MVC) architecture is used within portal server for the control, display, and reference of data. The portlet receives a request from a Web client, accesses the data via the use of enterprise Java Beans (EJBs), and displays the results of the request via HTML, typically within the context of a Java server page (JSP). The call is issued via HTTP/S in these examples. A data structure referencing the portlets in the container is updated (step 702). An example data structure is a hash data in which a unique key is generated to reference each instance of the portlet. In this illustrative example, the update includes generating a key for an entry for the added portlet and placing information for that portlet in that entry.

Next, the contents of the portal page are updated to include a tab for the portlet (step 704). These tabs are similar to those illustrated in window 404 in FIG. 4. The container is updated to create a linkage between the tab and the added portlet (step 706) with the process terminating thereafter. Portlets in these examples implement the ActionListener interface, which is an interface defined in Java used to receive events used for processing. When an action, driven by the portlet container, is issued to a specific portlet (or broadcasted to all portlets), the portlet receives the notification and performs the specified function.

A user also may initiate removal of a portlet from a portlet window. In initiating this type of function, a process similar to that illustrated in FIG. 7. In removing a portlet, similar steps are preformed to remove the portlet from the container and to remove the tab from the portal page.

With reference to FIG. 8, a flowchart of a process for performing functions on portlets in a container is depicted in accordance with a preferred embodiment of the present invention. The process illustrated in FIG. 8 may be implemented in a container process, such as container process 426 in FIG. 4.

The process begins by receiving a request for a portlet with a container (step 800). A function in the request is identified (step 802). This function may be, for example, print, close, or refresh. Next, the portlet for the function is identified (step 804). More than one portlet may be identified for the function that is to be preformed. Functions may be defined to apply to more than one portlet within the container. For example, a close function or a print function may apply to all of the portlets in the container.

The identified function is then initiated for the identified portlet or portlets (step 806) with the process terminating thereafter. In these examples, the container process may make different calls to the portlets to perform the identified function. An action event is triggered when the portlet container issues an action event that is sent to the portlet. When the HTTP request is received, this request is associated with a PortletAction object. A universal resource identifier (URI) references the action associated with the PortletAction object. Portlets implement the ActionListener interface to receive action notifications.

Thus, The present invention provides an improved method, apparatus, and computer instructions for managing the presentation of portlets in a single window on a page. The mechanism of the present inventions employs a container to group portlets together. Tabs are provided for the user to initiate functions on different portlets. For example, selection of a tab for a portlet results in the portlet being displayed in the portlet window on the portal page. Further, this grouping of portlets allows for functions to be preformed among the grouped portlets. Further, a single action may be initiated against all of the portlets in the container.

In this manner, the real estate needed to present portlets is reduced. Additionally, common functions may be provided for all the portlets.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for presenting a document, the method comprising:
presenting a set of portlets using a single portlet window in the document, wherein the portlet window includes a set of tabs; and
responsive to a selection of a particular tab in the set of tabs, presenting content for a particular portlet associated with the particular tab in the set of tabs.

2. The method of claim 1 further comprising:
grouping portlets into the set of portlets through a user input selecting the portlets.

3. The method of claim 1, wherein the document is a Web page.

4. The method of claim 1 further comprising:
providing a function for all portlets in the set of portlets.

5. The method of claim 1, wherein the function is at least one of close all portlets and print all portlets.

6. The method of claim A1 further comprising:
providing a function only for the particular portlet.

7. A method in a data processing system for managing portlets, the method comprising:
receiving a request from a requester to add a portlet to a portal page;
adding the portlet to a container for the portal page, wherein the contain is used to group a set of portlets for a portlet window;
obtaining content for the portlet; and
sending data for the portlet to the requester.

8. The method of claim 7, wherein the adding step includes
updating tabs for the portlet window to include a tab for the portlet; and
creating a link between the tab and the portlet.

9. The method of claim 7, wherein the data is data for a refresh of the portal page.

10. The method of claim 7, wherein the container identifies a set of functions common to all portlets in the container.

11. A data processing system for presenting a document, the data processing system comprising:
first presenting means for presenting a set of portlets using a single portlet window in the document, wherein the portlet window includes a set of tabs; and
second presenting means, responsive to a selection of a particular tab in the set of tabs, for presenting content for a particular portlet associated with the particular tab in the set of tabs.

12. The data processing system of claim 11 further comprising:
grouping means for grouping portlets into the set of portlets through a user input selecting the portlets.

13. The data processing system of claim 11, wherein the document is a Web page.

14. The data processing system of claim 11 further comprising:
providing means for providing a function for all portlets in the set of portlets.

15. The data processing system of claim 11, wherein the function is at least one of close all portlets and print all portlets.

16. The data processing system of claim 11 further comprising:
providing means for providing a function only for the particular portlet.

17. A data processing system in a data processing system for managing portlets, the method comprising:
receiving means for receiving a request from a requester to add a portlet to a portal page;
adding means for adding the portlet to a container for the portal page, wherein the contain is used to group a set of portlets for a portlet window;
obtaining means for obtaining content for the portlet; and
sending means for sending data for the portlet to the requester.

18. The data processing system of claim 17, wherein the adding means includes;
updating means for updating tabs for the portlet window to include a tab for the portlet; and
creating means for creating a link between the tab and the portlet.

19. The data processing system of claim 17, wherein the data is data for a refresh of the portal page.

20. The data processing system of claim 17, wherein the container identifies a set of functions common to all portlets in the container.
